(19) United States
(12) Patent Application Publication
(10) Pub. No.: US 2024/0241305 A1
(43) Pub. Date: Jul. 18, 2024

(54) LIGHT GUIDE PLATE APPARATUS AND IMAGE DISPLAY APPARATUS

(71) Applicant: SONY GROUP CORPORATION, Tokyo (JP)

(72) Inventor: Hidehiko TAKANASHI, Tokyo (JP)

(73) Assignee: SONY GROUP CORPORATION, Tokyo (JP)

(21) Appl. No.: 18/562,499

(22) PCT Filed: Feb. 2, 2022
(86) PCT No.: PCT/JP2022/003915

§ 371 Date: Nov. 20, 2023

(30) Foreign Application Priority Data
May 28, 2021 (JP) 2021-090236

(51) Int. Cl. F21V 8/00

(52) U.S. Cl. CPC G02B 6/0076; G02B 6/0065; G02B 6/0088

(57) ABSTRACT

To provide a light guide plate apparatus capable of accurately guiding incident light. A light guide plate apparatus according to the present technology includes: a plurality of stacked light guide plates; a first optical system that causes incident light to enter each of the plurality of light guide plates so as to satisfy a total internal reflection condition inside the light guide plate; a second optical system that causes the light propagating inside each of the plurality of light guide plates while being totally internally reflected to be emitted outward from the light guide plate; and at least one spacer provided between two adjacent light guide plates of the plurality of light guide plates, in which the spacer is arranged at a position deviated from a total internal reflection position of the light in opposite surfaces of each of the two adjacent light guide plates.

### TECHNICAL FIELD

The technology according to the present disclosure (hereinafter, also referred to as “present technology”) relates to a light guide plate apparatus and an image display apparatus.

### BACKGROUND ART

Conventionally, there is known an optical element with two adjacent substrates of a plurality of stacked light transmissive substrates fixed via an adhesion layer including a gap material (e.g., see Patent Literature 1).

### CITATION LIST

### Patent Literature

Patent Literature 1: Japanese Patent Application Laid-open No. 2017-173486

### DISCLOSURE OF INVENTION

### Technical Problem

However, the conventional optical element has room for improvement in accurately guiding incident light.

In view of this, it is a main object of the present technology to provide a light guide plate apparatus capable of accurately guiding incident light.

### Solution to Problem

The present technology provides a light guide plate apparatus according to the present technology including:
a plurality of stacked light guide plates;
a first optical system that causes incident light to enter each of the plurality of light guide plates so as to satisfy a total internal reflection condition inside the light guide plate;
a second optical system that causes the light propagating inside each of the plurality of light guide plates while being totally internally reflected to be emitted outward from the light guide plate; and
at least one spacer provided between two adjacent light guide plates of the plurality of light guide plates, in which
the spacer is arranged at a position deviated from a total internal reflection position of the light in opposite surfaces of each of the two adjacent light guide plates.

The at least one spacer may include a spacer or portion positioned inside an outer peripheral portion of each of the two adjacent light guide plates in a planar view.

The at least one spacer may include a spacer or portion positioned at the outer peripheral portion in a planar view.

The at least one spacer may include a spacer or portion positioned in a propagation region of the light between the first optical system and the second optical system in a planar view.

Each of the plurality of light guide plates may have a plurality of total internal reflection positions, and the at least one spacer may include a spacer or portion positioned between two adjacent total internal reflection positions of the plurality of total internal reflection positions in a planar view, the two adjacent total internal reflection positions being adjacent to each other in a propagation direction of the light.

The at least one spacer may include a spacer crossing a propagation region of the light between the first optical system and the second optical system in a planar view.

The at least one spacer may include at least two spacers arranged side by side so that the at least two spacers cross a propagation region of the light between the first optical system and the second optical system in a planar view.

The at least one spacer may include a spacer or portion positioned outside a propagation region of the light between the first optical system and the second optical system in a planar view.

The at least one spacer may include a spacer or portion positioned inside an outer peripheral portion of each of the two adjacent light guide plates and outside a propagation region of the light in a planar view.

The at least one spacer may include at least one first spacer arranged inside a propagation region of the light between the first optical system and the second optical system and at least one second spacer arranged outside the propagation region in a planar view, and the first spacer and the second spacer may be different in arrangement density.

The arrangement density of the second spacer may be higher than the arrangement density of the first spacer.

The at least one spacer may include a first portion positioned inside a propagation region of the light between the first optical system and the second optical system and a second portion positioned outside the propagation region in a planar view, and the first portion and the second portion may be different in area density.

The area density of the second portion may be higher than the area density of the first portion.

The at least one spacer may include a linear or curved spacer or portion.

The at least one spacer may include a dot-like spacer.

The at least one spacer may include a frame-like spacer or portion.

The first optical system may include a first diffraction optical element provided in each of the plurality of light guide plates, and an incident optical system that causes the light to enter the first diffraction optical element, and the second optical system may include a second diffraction optical element provided in each of the plurality of light guide plates.

At least one diffraction optical element including a third diffraction optical element may be arranged on a propagation path of the light between the first diffraction optical element and the second diffraction optical element provided in each of the plurality of light guide plates.

The third diffraction optical element may bend the light from the first diffraction optical element toward the second diffraction optical element.

The at least one spacer may be formed by photolithography.

The at least one spacer may be constituted by a polymerizable resin.

The at least one spacer may be a photospacer.

The at least one spacer may be a permanent resist.

The at least one spacer may have a dimension of 500 μm or less in a direction along an in-plane direction of each of the two adjacent light guide plates.

The at least one spacer may have a dimension of 100 μm or less in a direction along an in-plane direction of each of the two adjacent light guide plates.

The present technology also provides an image display apparatus including:
the above-mentioned light guide plate apparatus; and
an image light generation apparatus that generates image light and causes the image light to enter the first optical system of the light guide plate apparatus, in which
the first optical system causes different parts of the incident image light to respectively enter a plurality of light guide plates of the light guide plate apparatus, and
the second optical system of the light guide plate apparatus causes light propagating inside each of the plurality of light guide plates to be emitted toward an eyeball of a user.

The first optical system may split the image light and cause the plurality of split light rays to enter the different light guide plates.

The plurality of light rays may have different wavelengths.

### BRIEF DESCRIPTION OF DRAWINGS

FIG. 1 A is a plan view a light guide plate apparatus according to an embodiment of the present technology. FIG. 1 B is a cross-sectional view taken along the line A-A in FIG. 1 A.

FIG. 2 A cross-sectional view of an image display apparatus including the light guide plate apparatus according to the embodiment of the present technology.

FIG. 3 A block diagram showing functions of an image light generation apparatus of the image display apparatus in FIG. 2.

FIG. 4 A flowchart showing an example of a manufacturing method for the light guide plate apparatus according to the embodiment of the present technology.

FIG. 5 A is a plan view of a light guide plate apparatus according to Modified Example 1 of the embodiment of the present technology. FIG. 5 B is a cross-sectional view taken along the line A1-A1 in FIG. 5A.

FIG. 6 A is a plan view of a light guide plate apparatus according to Modified Example 2 of the embodiment of the present technology. FIG. 6 B is a cross-sectional view taken along the line A2-A2 in FIG. 6A.

FIG. 7 A is a plan view of a light guide plate apparatus according to Modified Example 3 of the embodiment of the present technology. FIG. 7 B is a cross-sectional view taken along the line B3-B3 in FIG. 7A. FIG. 7 C is a cross-sectional view taken along the line C3-C3 in FIG. 7A.

FIG. 8 A is a plan view of a light guide plate apparatus according to Modified Example 4 of the embodiment of the present technology. FIG. 8 B is a cross-sectional view taken along the line A4-A4 in FIG. 8A.

FIG. 9 A is a plan view of a light guide plate apparatus according to Modified Example 5 of the embodiment of the present technology. FIG. 9 B is a cross-sectional view taken along the line A5-A5 in FIG. 9A.

FIG. 10 A is a plan view of a light guide plate apparatus according to Modified Example 6 of the embodiment of the present technology. FIG. 10 B is a cross-sectional view taken along the line A6-A6 in FIG. 10A.

FIG. 11 A is a plan view of a light guide plate apparatus according to Modified Example 7 of the embodiment of the present technology. FIG. 11 B is a cross-sectional view taken along the line B7-B7 in FIG. 11A. FIG. 11 C is a cross-sectional view taken along the line C7-C7 in FIG. 10A.

FIG. 12 A is a plan view of a light guide plate apparatus according to Modified Example 8 of the embodiment of the present technology. FIG. 12 B is a cross-sectional view taken along the line A8-A8 in FIG. 12A.

FIG. 13 A is a plan view of a light guide plate apparatus according to Modified Example 9 of the embodiment of the present technology. FIG. 13 B is a cross-sectional view taken along the line A9-A9 in FIG. 13A.

FIG. 14 A is a plan view of a light guide plate apparatus according to Modified Example 10 of the embodiment of the present technology. FIG. 14 B is a cross-sectional view taken along the line A10-A10 in FIG. 14A.

FIG. 15 A is a plan view of a light guide plate apparatus according to Modified Example 11 of the embodiment of the present technology. FIG. 15 B is a cross-sectional view taken along the line A11-A11 in FIG. 15A.

FIG. 16 A is a plan view of a light guide plate apparatus according to Modified Example 12 of the embodiment of the present technology. FIG. 16 B is a cross-sectional view taken along the line A12-A12 in FIG. 16A.

FIG. 17 A is a plan view of a light guide plate apparatus according to Modified Example 13 of the embodiment of the present technology. FIG. 17 B is a cross-sectional view taken along the line A13-A13 in FIG. 17A.

### MODE(S) FOR CARRYING OUT THE INVENTION

Hereinafter, favorable embodiments of the present technology will be described in detail with reference to the accompanying drawings. It should be noted that in the present specification and the drawings, components having substantially the same functional configurations will be denoted by the same reference signs and duplicate descriptions thereof will be omitted. The embodiments described below represent typical embodiments of the present technology. The scope of the present technology should not be understood narrowly due to these embodiments. In the present specification, even in a case where it is described that a light guide plate apparatus and an image display apparatus according to the present technology provide a plurality of effects, the light guide plate apparatus and the image display apparatus according to the present technology only need to provide at least one of the effects. The effects described in the present specification are merely exemplary and not limitative and other effects may be provided.

Moreover, descriptions will be given in the following order.
1. Introduction
2. Image Display Apparatus Including Light Guide Plate Apparatus and Light Guide Plate Apparatus According to Embodiment of Present Technology
(1) Configurations of Light Guide Plate Apparatus and Image Display Apparatus
(2) Manufacturing Method for Light Guide Plate Apparatus
(3) Effects of Light Guide Plate Apparatus and Image Display Apparatus
3. Light Guide Plate Apparatuses According to Modified Examples 1 to 13 of Embodiment of Present Technology
4. Modified Examples of Present Technology

### 1. Introduction

Conventionally, there is known an image display apparatus (e.g., a head-mounted display) that guides image light to an eyeball of a user who is an observer by causing image light to enter a light guide plate so that the image light propagates while experiencing total internal reflection in the light guide plate and causing the image light to be emitted outward from the light guide plate.

However, in a case of causing a plurality of light beams that constitutes the image light to propagate while experiencing total internal reflection in a single (identical) light guide plate, an advanced optical design has been required for accurately guiding each light beam to the eyeball of the user. In particular, in a case of causing a plurality of light beams having different wavelengths that constitutes the image light to propagate while experiencing total internal reflection in the single light guide plate, a highly advanced optical design has been required for accurately guiding each light beam to the eyeball of the user because the plurality of light beams has different refractive indices in the light guide plate.

In view of such problems, the inventors focused on the fact that allocating a plurality of light beams that constitute the image light to a plurality of stacked light guide plates and causing the plurality of light beams to propagate while experiencing total internal reflection enables each light beam to be accurately guided to the eyeball of the user without requiring an advanced optical design.

By the way, in a case of stacking the plurality of light guide plates, it is necessary to provide a gap (clearance) between two adjacent light guide plates in a stacking direction in order to cause the light to experience total internal reflection in each light guide plate.

For example, according to Patent Literature 1, outer peripheral portions of two adjacent substrates of a plurality of substrates stacked are fixed to each other via an adhesion layer including a gap material.

However, if the gap is provided between the light guide plates by fixing the outer peripheral portions of the light guide plates to each other via the adhesion layer including the gap material, bending, distortion, or the like of the light guide plate causes gap variations between the light guide plates (lowers uniformity of the gap between the light guide plates), which deteriorates the flatness of the total internal reflection surface of each light guide plate. Therefore, the plurality of light beams that constitute the image light cannot be accurately guided to the eyeball of the user.

In view of such a problem, the inventors has made a light guide plate apparatus capable of accurately guiding incident light and an image display apparatus capable of accurately guiding the plurality of light beams that constitute the image light to the eyeball of the user by using the light guide plate apparatus.

### 2. Image Display Apparatus Including Light Guide Plate Apparatus and Light Guide Plate Apparatus According to Embodiment of Present Technology

A light guide plate apparatus according to an embodiment of the present technology and an image display apparatus including the light guide plate apparatus will be described with reference to the drawings.

The light guide plate apparatus according to the embodiment and the image display apparatus including the light guide plate apparatus can be used for the purpose of providing augmented reality (AR) to the user, for example.

### (1) Configurations of Light Guide Plate Apparatus and Image Display Apparatus

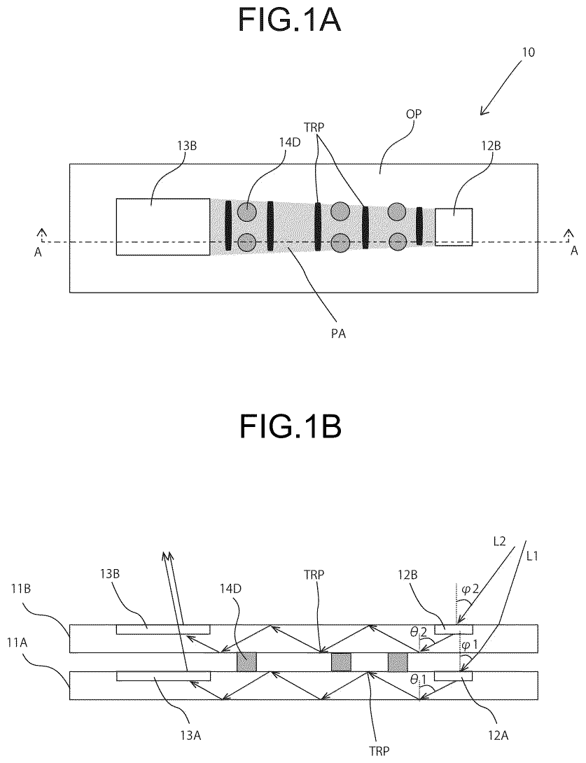

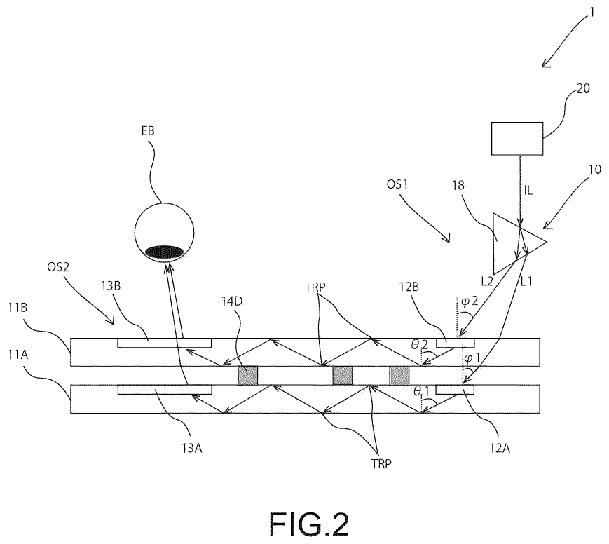

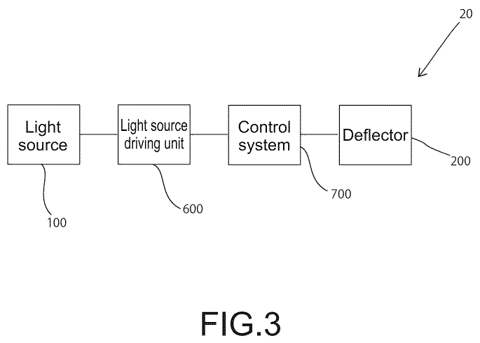

FIG. 1A is a plan view of a light guide plate apparatus 10 according to the embodiment. FIG. 1B is a cross-sectional view taken along the line A-A in FIG. 1A. FIG. 2 is a cross-sectional view of an image display apparatus 1 including the light guide plate apparatus 10 according to the embodiment. FIG. 3 is a block diagram showing functions of an image light generation apparatus 20 of the image display apparatus 1.
The image display apparatus 1 functions as a head-mounted display (HMD) used, put on the head of the user, for example. The HMD is also called eyewear, for example.

As shown in FIGS. 1 and 2, the image display apparatus 1 includes the image light generation apparatus 20 as well as the light guide plate apparatus 10. The light guide plate apparatus 10 and the image light generation apparatus 20 are integrally provided in, for example, an identical support structure (e.g., a eyeglasses frame).

Hereinafter, the description will be continued assuming that an eyeglasses frame as an example of the support structure is put on the head of the user.

### [Image Light Generation Apparatus]

The image light generation apparatus 20 generates image light IL (see FIG. 2).

The image light generation apparatus 20 includes a light source 100, a deflector 200, a light source driving unit 600, and a control system 700, for example, as shown in FIG. 3.

### (Light Source)

The light source 100 is favorably a laser light source or a light-emitting diode light source. The laser light source can be a semiconductor laser, e.g., an edge emitting laser (EEL) or a surface emitting laser (SEL).

### (Light Source Driving Unit)

The light source driving unit 600 (e.g., a laser driver) drives the light source 100 on the basis of modulation data to be described later, which is sent from the control system 700.

### (Deflector)

The deflector 200 includes a movable mirror capable of moving about two axes orthogonal to each other, such as a MEMS mirror, a galvanometer mirror, and a polygon mirror, for example. It should be noted that the deflector 200 may include a first movable mirror capable of moving about one axis and a second movable mirror capable of moving about another axis orthogonal to the one axis.

### (Control System)

The control system 700 controls the light source 100 via the light source driving unit 600. In addition, the control system 700 controls the deflector 200 in synchronization with the control of the light source 100.

Hardware such as a CPU and a chip set achieves the control system 700.

The control system 700 generates modulation data on the basis of image data input from an external apparatus or input via a network and sends the generated modulation data to the light source driving unit 600.

In the image light generation apparatus 20, the deflector 200 two-dimensionally deflects the light from the light source 100 driven by the light source driving unit 600 in accordance with the modulation data from the control system 700. As a result, the image light IL is generated.

It should be noted that the image light generation apparatus 20 may be, for example, a combination of a liquid-crystal panel and a back light that, for example, has a plurality of pixels arranged two-dimensionally and emits light for each pixel or for each pixel block including at least two pixels. In this case, the light-emitting diode light source, for example, can be used as the back light.

### [Light Guide Plate Apparatus]

The light guide plate apparatus 10 includes a plurality of (e.g., two) stacked light guide plates (e.g., first and second light guide plates 11A and 11B), a first optical system OS1, a second optical system OS2, and a plurality of (e.g., six) spacers 14D, for example, as shown in FIGS. 1A and 2.

The plurality of light guide plates (the first and second light guide plates 11A and 11B) is stacked via the spacers 14D.

Hereinafter, the plurality of stacked light guide plates (e.g., the first and second light guide plates 11A and 11B) will also be collectively referred to as a “light guide plate laminate”.

Here, the light guide plate laminate has a two-layer structure.

### (Light Guide Plate)

As shown in FIG. 2, the light guide plate laminate faces an eyeball EB of the user in a stacking direction (hereinafter, simply also referred to as “stacking direction”) of the plurality of light guide plates (e.g., the first and second light guide plates 11A and 11B). To be more specific, in the light guide plate laminate, the second light guide plate 11B is located at a position facing the eyeball EB of the user and the first light guide plate 11A is positioned on a side pf the second light guide plate 11B which is opposite to the side of the eyeball EB.

Each of the first and second light guide plates 11A and 11B is constituted by a transparent glass plate or resin plate, for example. Each light guide plate has a thickness of, for example, 0.1 mm to 1.0 mm and favorably has a thickness of, for example, 0.4 mm to 0.6 mm.

The materials (refractive indices) of the first and second light guide plates 11A and 11B may be the same or may be different.

The first and second light guide plates 11A and 11B may be fixed with an adhesion or may be mechanically fixed with a clamp or the like when they are stacked via the plurality of spacers 14D.

### (First Optical System)

The first optical system OS1 causes different parts of the incident light (e.g., the image light IL) to respectively enter the first and second light guide plates 11A and 11B so as to satisfy a total internal reflection condition inside the light guide plate (at an incident angle that satisfies a total internal reflection condition). The image light IL generated by the image light generation apparatus 20 is made incident on the first optical system OS1.

The first optical system OS1, for example, includes a prism 18 (incident optical system) and a plurality of (e.g., two) first diffraction optical elements 12A and 12B.

The prism 18 is, for example, arranged on an optical path of the image light IL generated by the image light generation apparatus 20 and splits light per pixel of the image light IL into a plurality of (e.g., two) light rays L1 and L2 having different wavelengths.

The first diffraction optical element 12A is provided, for example, on an optical path of light L1 split by the prism 18 and on a side of one end portion of a surface of the first light guide plate 11A, which is on an incident side of the light L1 (a surface on a side of the second light guide plate 11B). In FIG. 1A, the first diffraction optical element 12A is hidden under the first diffraction optical element 1213A. The light L1 from the prism 18 is made incident on the first diffraction optical element 12A via the second light guide plate 11B (passing through the second light guide plate 11B). To be more specific, the light L1 from the prism 18 is refracted on a surface of the second light guide plate 11B, which is on a side opposite to a side of the first light guide plate 11A, and a surface on the side of the first light guide plate 11A, and is made incident on the first diffraction optical element 12A at an incident angle φ1.

The first diffraction optical element 12A, for example, transmits and diffracts the light L1 incident thereon at the incident angle φ1 and causes the light L1 to enter an inner surface (total internal reflection surface) of the first light guide plate 11A, which is on a side opposite to the side of the second light guide plate 11B, at an incident angle θ1 (an incident angle equal to or larger than a critical angle) that satisfies the total internal reflection condition in the first light guide plate 11A.

The first diffraction optical element 12B is provided, for example, on an optical path light L2 split by the prism 18 and on a side of one end portion of a surface of the second light guide plate 11B, which is on an incident side of the light L2 (a surface on a side opposite to the side of the first light guide plate 11A). The light L2 from the prism 18 is made incident on the first diffraction optical element 12B at an incident angle φ2. It should be noted that φ2=φ1 may be established or φ2≠φ1 may be established.

The first diffraction optical element 12B, for example, transmits and diffracts the light L2 incident at the incident angle φ2 and causes the light L2 to enter an inner surface (a total internal reflection surface) of the second light guide plate 11B, which is on the side of the first light guide plate 11A, at an incident angle θ2 that satisfies the total internal reflection condition in the second light guide plate 11B (the incident angle equal to or larger than the critical angle). It should be noted that θ2=θ1 may be established or θ2≠θ1 may be established.

### (Second Optical System)

The second optical system OS2, for example, causes the light propagating while being totally internally reflected inside each of the first and second light guide plates 11A and 11B to be emitted outward from the light guide plate.

The second optical system OS2, for example, includes a plurality of (e.g., two) second diffraction optical elements 13A and 13B.

The second diffraction optical element 13A, for example, is provided on an optical path of the light L1 propagating while being totally internally reflected inside the first light guide plate 11A and on a side of the other end portion of a surface of the first light guide plate 11A, which is on the side of the eyeball EB (a surface on the side of the second light guide plate 11B). In FIG. 1A, the second diffraction optical element 13A is hidden under the second diffraction optical element 13B.

The second diffraction optical element 13A, for example, transmits and diffracts the light L1 propagating while being totally internally reflected inside the first light guide plate 11A and causes the light L1 to be emitted outward from the first light guide plate 11A. The light L1 emitted outward from the first light guide plate 11A is made incident on the eyeball EB via the second light guide plate 11B and the second diffraction optical element 13B (passing through it). To be more specific, the light L1 emitted outward from the first light guide plate 11A is refracted on a surface of the second light guide plate 11B, which is on the side of the first light guide plate 11A, passes through the second diffraction optical element 13A, and is made incident on the eyeball EB.

The second diffraction optical element 13B is provided, for example, on an optical path of the light L2 propagating while being totally internally reflected inside the second light guide plate 11B and on a side of the other end portion of a surface of the second light guide plate 11B, which is on the side of the eyeball EB (a surface on a side opposite to the side of the first light guide plate 11A).

The second diffraction optical element 13B, for example, transmits and diffracts the light L2 propagating while being totally internally reflected inside the second light guide plate 11B and causes the light L2 to be emitted outward from the second light guide plate 11B. The light L2 emitted outward from the second light guide plate 11B is made incident on the eyeball EB.

The light L1 and the light L2 emitted from the second optical system OS2 including the second diffraction optical elements 13A and 13B are made incident on substantially the same position on the eyeball EB and the user can visually recognize an image formed by the light per pixel of the image light IL.

Each diffraction optical element may be formed by working the surface of the corresponding light guide plate, for example, or may be attached to the surface of this light guide plate. Here, each diffraction optical element also includes a holographic optical element (HOE) in addition to a diffractive optical element (DOE) in a broad meaning.

### (Spacer)

By the way, spacers are essential for forming a gap between the two adjacent light guide plates in the stacking direction (for forming the total internal reflection surface) irrespective of what type of light guide plates are used for the light guide plate laminate.

At that time, it is desirable to devise the lay-out of the spacers in order to reduce bending, distortion, or the like of each light guide plate (in order to reduce gap variations between the light guide plates). In particular, in a case of using a thin light guide plate as each light guide plate in order to reduce the entire thickness of the light guide plate laminate, bending, distortion, or the like readily occurs in this light guide plate. Moreover, also in a case of using a resin plate having lower rigidity than a glass plate as each light guide plate, bending, distortion, or the like readily occurs in this light guide plate. It should be noted that since bending, distortion, or the like that can occur in each light guide plate deteriorates the flatness of the total internal reflection surface of such a light guide plate, it affects the accuracy of propagation of the light propagating while being totally internally reflected in such a light guide plate. That is, since the spacers cannot sufficiently reduce bending, distortion, or the like of the light guide plate depending on arrangement, it indirectly affects the accuracy of propagation of the light.

In addition, the spacers are desirably arranged at positions where the spacers do not directly affect the accuracy of propagation of the light propagating while being totally internally reflected in each light guide plate. As a supplement, if the spacers are arranged at positions corresponding to total internal reflection positions on the light guide plate, there is a fear that total internal reflection of the light at a desired (predetermined) total internal reflection angle does not occur at these total internal reflection positions.

Moreover, in a light guide plate apparatus used for a see-through-type image display apparatus, it is also desirable that the spacer arranged between the two adjacent light guide plates be as less noticeable as possible so as not to be visually recognized by the user and others as an unnecessary image.

In the present embodiment, the material, shape, size, arrangement, and the like of the spacers are devised as follows in consideration of the above-mentioned problem.

The plurality of (e.g., six) spacers 14D is provided between the first and second light guide plates 11A and 11B as shown in FIG. 1A and FIG. 1B. The respective spacers 14D are arranged at positions deviated from total internal reflection positions TRP of the light rays L1 and L2 on opposite surfaces of each of the first and second light guide plates 11A and 11B (positions where the spacers 14D do not directly affect propagation of the light in each light guide plate).

The plurality of (e.g., six) spacers 14D includes six spacers 14D positioned inside an outer peripheral portion OP of each of the first and second light guide plates 11A and 11B for example, in a planar view (as viewed in a direction substantially orthogonal to each light guide plate (a thickness direction of each light guide plate)).

Here, in a planar view, the first diffraction optical element 12A and the second diffraction optical element 13A are arranged inside the outer peripheral portion OP of the first light guide plate 11A and a propagation region PA (grey region in FIG. 1A) of the light rays L1 and L2 and the total internal reflection positions TRP are located between the first diffraction optical element 12A and the second diffraction optical element 13A. Similarly, in a planar view, the first diffraction optical element 12B and the second diffraction optical element 13B are arranged inside the outer peripheral portion OP of the second light guide plate 11B and the propagation region PA (grey region in FIG. 1A) of the light rays L1 and L2 and the total internal reflection positions TRP are located between the first diffraction optical element 12B and the second diffraction optical element 13B.

Each of the first and second light guide plates 11A and 11B includes a plurality of total internal reflection positions TRP. To be more specific, the total internal reflection positions TRP periodically appear in the propagation region PA on the opposite surfaces of each light guide plate in accordance with a total internal reflection angle depending on the incident angle of the light on the total internal reflection surface of each light guide plate (incident angle equal to or larger than the critical angle) and the thickness of the light guide plate.

The plurality of (e.g., six) spacers 14D is positioned, for example, in the propagation region PA of the light rays L1 and L2 between the first and second optical systems OS1 and OS2 in a planar view (see FIG. 1A).

Each of the plurality of spacers 14D is positioned between two adjacent total internal reflection positions TRP of the plurality of total internal reflection positions TRP, which are adjacent to each other in the propagation direction of the light, in a planar view (see FIG. 1A).

The plurality of spacers 14D is, for example, dot-like spacers. Here, the plurality of spacers 14D each has a circular shape in a planar view. However, the plurality of spacers 14D may each have other shape such as an elliptical shape in a planar view and a polygonal shape in a planar view. The plurality of spacers 14D all has the same shape in a planar view. However, the plurality of spacers 14D may include at least two spacers different from each other in shape. The plurality of spacers 14D all has the same size in a planar view. However, the plurality of spacers 14D may include at least two spacers different from each other in size.

Here, the size is limited because the respective spacers 14D need to be arranged at the positions deviated from the total internal reflection positions TRP in the propagation region PA. Specifically, a dimension (e.g., a diameter) of each spacer 14D in a direction along an in-plane direction of each of the two adjacent first light guide plates 11A and 11B is favorably 500 μm or less. In addition, the dimension (e.g., the diameter) of each spacer 14D in the direction along the in-plane direction of each of the two adjacent first and second light guide plates 11A and 11B is more favorably 100 μm or less.

The plurality of spacers 14D is favorably constituted by a polymerizable resin, for example. Examples of the polymerizable resin includes Optomer NN series manufactured by JSR Corporation, Resist for photo spacer manufactured by OSAKA ORGANIC CHEMICAL INDUSTRY LTD., TPSR series manufactured by TOKYO OHKA KOGYO CO., LTD., and Photoclear (trademark) manufactured by TORAY INDUSTRIES, INC. Specifically, the plurality of spacers 14D may be photospacers or may be constituted by a permanent resist. For example, photospacers used for LCD or permanent resists used for MEMS have excellent in-plane uniformity in the resist thickness, so the gap can be formed between the light guide plates with a very high accuracy. Moreover, the photospacer, the spacer constituted by the permanent resist, or the like can be generated by forming the resist with desired shape and size at a desired position by photolithography. Therefore, lay-out that does not affect the optical properties of the light guide plate can be achieved.

### (2) Manufacturing Method for Light Guide Plate Apparatus

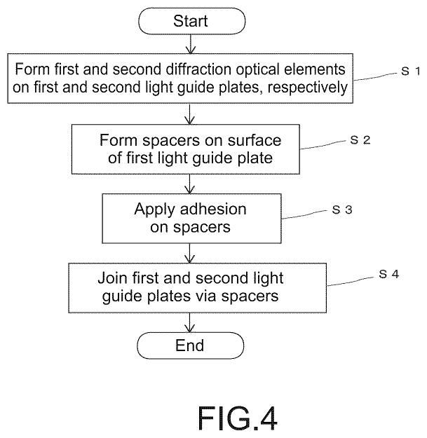

Hereinafter, an example of a manufacturing method for the light guide plate apparatus 10 will be described with reference to a flowchart in FIG. 4.

In first Step S1, a first diffraction optical element and a second diffraction optical element are formed on the first and second light guide plates 11A and 11B, respectively.

In next Step S2, a plurality of spacers 14D is formed on the surface of the first light guide plate 11A. Specifically, the plurality of spacers 14D is patterned on the surface of the first light guide plate 11A by photolithography.

In next Step S3, an adhesion is applied on the plurality of spacers 14D. It should be noted that in Step S3, the adhesion may be applied also on an outer peripheral portion OP of the first light guide plate 11A.

In final Step S4, the first and second light guide plates 11A and 11B are joined via the plurality of spacers 14D. Specifically, the first and second light guide plates 11A and 11B are joined with the adhesion applied on the plurality of spacers 14D after the first light guide plate 11A and the second light guide plate 11B are positioned in the in-plane direction. In Step S3, in a case where the adhesion is applied also on the outer peripheral portion OP of the first light guide plate 11A, the first and second light guide plates 11A and 11B can be joined also with such an adhesion.

It should be noted that in Step S3, an adhesion may be applied on an outer peripheral portion of the first light guide plate 11A rather than applying the adhesion on the plurality of spacers 14D, and in Step S4, the first and second light guide plates 11A and 11B may be joined only with the adhesion applied on the outer peripheral portion of the first light guide plate 11A.

### (3) Effects of Light Guide Plate Apparatus and Image Display Apparatus

The light guide plate apparatus 10 according to the embodiment of the present technology includes the plurality of stacked light guide plates (e.g., the first and second light guide plates 11A and 11B), the first optical system OS1 that causes the incident light to enter each of the plurality of light guide plates 11A and 11B so as to satisfy the total internal reflection condition inside the light guide plate, the second optical system OS2 that causes the light propagating while being totally internally reflected inside each of the plurality of light guide plates 11A and 11B to be emitted outward from the light guide plate, and at least one spacer (e.g., the plurality of spacers 14D) provided between the two adjacent light guide plates (e.g., the first and second light guide plates 11A and 11B) of the plurality of light guide plates (e.g., the first and second light guide plates 11A and 11B), the spacer being arranged at a position deviated from the total internal reflection positions TRP of the light on the opposite surfaces of each of the two adjacent light guide plates (e.g., the first and second light guide plates 11A and 11B).

In this case, the respective spacers 14D are arranged at the positions where the spacers 14D do not directly affect propagation of the light in each light guide plate. Therefore, a light guide plate apparatus capable of accurately guiding incident light can be provided.

The plurality of spacers 14D includes spacers 14D positioned inside the outer peripheral portion of each of the two adjacent light guide plates 11A and 11B in a planar view. Accordingly, bending, distortion, or the like of each light guide plate can be effectively reduced and thus indirectly affecting propagation of the light in the light guide plate can be reduced.

The plurality of spacers 14D is positioned in the propagation region PA of the light between the first and second optical systems OS1 and OS2 in a planar view. Accordingly, in particular, bending, distortion, or the like of the propagation region PA of each light guide plate can be sufficiently reduced. Therefore, the flatness of the propagation region PA of the light guide plate can be enhanced and thus the accuracy of propagation of the light in the light guide plate can be enhanced.

Each of the plurality of light guide plates (e.g., the first and second light guide plates 11A and 11B) includes the plurality of total internal reflection positions TRP and each of the plurality of spacers 14D is positioned between the two adjacent total internal reflection positions TRP of the plurality of total internal reflection positions TRP, which are adjacent to each other in the propagation direction of the light, in a planar view. Accordingly, the flatness of the vicinity of each total internal reflection position TRP of each light guide plate can be enhanced and thus the accuracy of propagation of the light propagating while being totally internally reflected in the light guide plate can be further enhanced.

The plurality of spacers 14D is the dot-like spacers. In this case, each spacer 14D is less noticeable. It can prevent the user as the observer from recognizing the spacers as unnecessary images and can also prevent the others from feeling that the light guide plate apparatus 10 worn by the user is strange when they see it.

The first optical system OS1 includes the first diffraction optical element provided in each of the first and second light guide plates 11A and 11B and the prism 18 (incident optical system) that causes the light to enter each first diffraction optical element. The second optical system OS2 includes the second diffraction optical element provided in each of the first and second light guide plates 11A and 11B. Accordingly, the light can be accurately made incident on each light guide plate so as to satisfy the total internal reflection condition and the light propagating while being totally internally reflected in the light guide plate can be accurately made to be emitted outward from the light guide plate.

The plurality of spacers 14D is favorably formed by the photolithography. Accordingly, the spacers with desired shape and size can be formed at desired positions.

The plurality of spacers 14D is favorably constituted by the polymerizable resin. Accordingly, each spacer 14D can be formed by forming the resist by the photolithography.

The plurality of spacers 14D may be the photospacers. Accordingly, the uniformity of the gap between the first and second light guide plates 11A and 11B can be enhanced.

The plurality of spacers 14D may be constituted by the permanent resist. Accordingly, the uniformity of the gap between the first and second light guide plates 11A and 11B can be enhanced.

The dimension of each of the plurality of spacers 14D in the direction along the in-plane direction of each of the first and second light guide plates 11A and 11B is favorably 500 μm or less. Accordingly, the plurality of spacers 14D can be laid out relatively easily so that the plurality of spacers 14D are deviated from the total internal reflection positions TRP on the opposite surfaces of each light guide plate.

The dimension of each of the plurality of spacers 14D in the direction along the in-plane direction of each of the first and second light guide plates 11A and 11B is more favorably 100 μm or less. Accordingly, the plurality of spacers 14D can be laid out so easily so that the plurality of spacers 14D are deviated from the total internal reflection positions TRP on the opposite surfaces of each light guide plate.

The image display apparatus 1 includes the light guide plate apparatus 10 and the image light generation apparatus 20 that generates the image light IL and causes the image light IL to enter the first optical system OS1 of the light guide plate apparatus 10. The first optical system OS1 causes different parts of the incident image light IL to respectively enter the first and second light guide plates 11A and 11B of the light guide plate apparatus 10. The second optical system OS2 causes the light propagating inside each of the first and second light guide plates 11A and 11B to be emitted toward the eyeball of the user. Accordingly, the image light IL can be accurately guided to the eyeball of the user and thus the quality of the display image can be enhanced.

The first optical system OS1 splits the image light into the plurality of light rays having different wavelengths and causes the plurality of light rays to enter the different light guide plates. Accordingly, each of the plurality of light rays having different wavelengths can be accurately made to propagate in the corresponding light guide plate without requiring an advanced optical design.

### 3. Light Guide Plate Apparatuses According to Modified Examples 1 to 13 of Embodiment of Present Technology

Hereinafter, light guide plate apparatuses according to Modified Examples 1 to 13 of the embodiment of the present technology will be described with reference to the drawings. It should be noted that an image display apparatus including the light guide plate apparatus according to each of the modified examples below has a configuration substantially similar to that of the image display apparatus 1 including the light guide plate apparatus 10 according to the embodiment.

### Modified Example 1

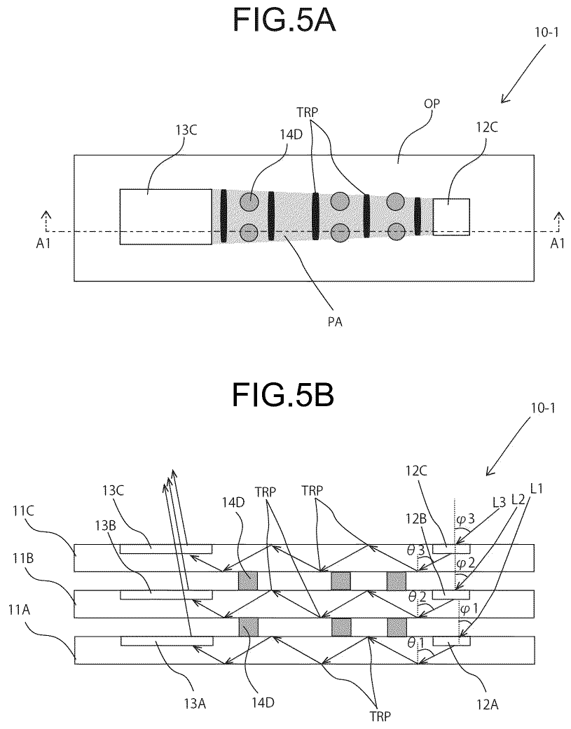

A light guide plate apparatus 10-1 according to Modified Example 1 has, as shown in FIG. 5A and FIG. 5 B (a cross-sectional view taken along the line A1-A1 in FIG. 5A), a configuration similar to the configuration of the light guide plate apparatus 10 according to the embodiment except for the fact that the light guide plate laminate has a three-layer structure.

That is, the light guide plate apparatus 10-1 includes a third light guide plate 11C on the second light guide plate 11B in addition to the first and second light guide plates 11A and 11B. A plurality of (e.g., six) spacers 14D is provided also between the second and third light guide plates 11B and 11C as between the first and second light guide plates 11A and 11B. A first diffraction optical element 12C and a second diffraction optical element 13C are provided in the third light guide plate 11C.

In the light guide plate apparatus 10-1, the first optical system OS1 splits light per pixel of the image light IL from the image light generation apparatus 20 into a plurality of (e.g., three) light rays L1, L2, and L3 having different wavelengths. For example, light in three colors of red (R), green (G), and blue (B) can be used as the light rays L1, L2, and L3.

The light L1 is made incident on the first diffraction optical element 12A at the incident angle φ1, is transmitted and diffracted by the first diffraction optical element 12A, is made incident on the inner surface (the total internal reflection surface) of the first light guide plate 11A at the incident angle θ1, propagates while being totally internally reflected in the first light guide plate 11A, and is transmitted and diffracted by the second diffraction optical element 13A, and is made incident on the eyeball of the user.

The light L2 is made incident on the first diffraction optical element 12B at the incident angle φ2, is transmitted and diffracted by the first diffraction optical element 12B, is made incident on the inner surface (the total internal reflection surface) of the second light guide plate 11B at the incident angle θ2, propagates while being totally internally reflected in the second light guide plate 11B, is transmitted and diffracted by the second diffraction optical element 13B, and is made incident on the eyeball of the user.

The light L3 is made incident on the first diffraction optical element 12C at an incident angle φ3, is transmitted and diffracted by the first diffraction optical element 12C, is made incident on the inner surface (the total internal reflection surface) of the second light guide plate 11C at the incident angle θ3, propagates while being totally internally reflected in the second light guide plate 11C, is transmitted and diffracted by the second diffraction optical element 13C, and is made incident on the eyeball of the user.

The light rays L1, L2, and L3 emitted from the second optical system OS2 including the second diffraction optical elements 13A and 13B, 13C are made incident on substantially the same position on the eyeball of the user. As a result, the user can visually recognize full-color image constituted by light forming all pixels of the image light IL.

The light guide plate apparatus 10-1 can be manufactured by a manufacturing method according to the manufacturing method for the light guide plate apparatus 10 according to the embodiment.

In accordance with the light guide plate apparatus 10-1, effects similar to those of the light guide plate apparatus 10 according to the embodiment can provided and each of three light rays having different wavelengths that are included in the incident light (e.g., the image light IL) can be accurately guided.

### Modified Example 2

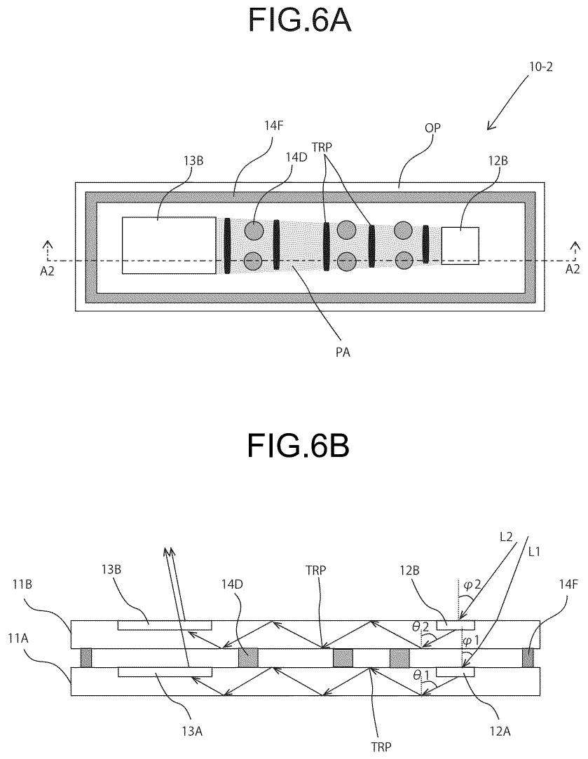

A light guide plate apparatus 10-2 according to Modified Example 2 has, as shown in FIG. 6A and FIG. 6 B (a cross-sectional view taken along the line A2-A2 in FIG. 6A), a configuration similar to the configuration of the light guide plate apparatus 10 according to the embodiment except for the fact that a frame-like spacer 14F is provided between the first and second light guide plates 11A and 11B.

The spacer 14F is positioned in the outer peripheral portions OP of the first and second light guide plates 11A and 11B in a planar view. The spacer 14F is a frame-like spacer arranged along the outer peripheral portions OP in a planar view.

The light guide plate apparatus 10-2 can be manufactured by a manufacturing method according to the manufacturing method for the light guide plate apparatus 10 according to the embodiment.

In accordance with the light guide plate apparatus 10-2, a plurality of (e.g., six) dot-like spacers 14D is arranged inside the outer peripheral portion OP of each light guide plate in a planar view and the frame-like spacer 14F is arranged in the outer peripheral portion OP of each light guide plate. Therefore, gap variations between the light guide plates can be reduced more stably.

### Modified Example 3

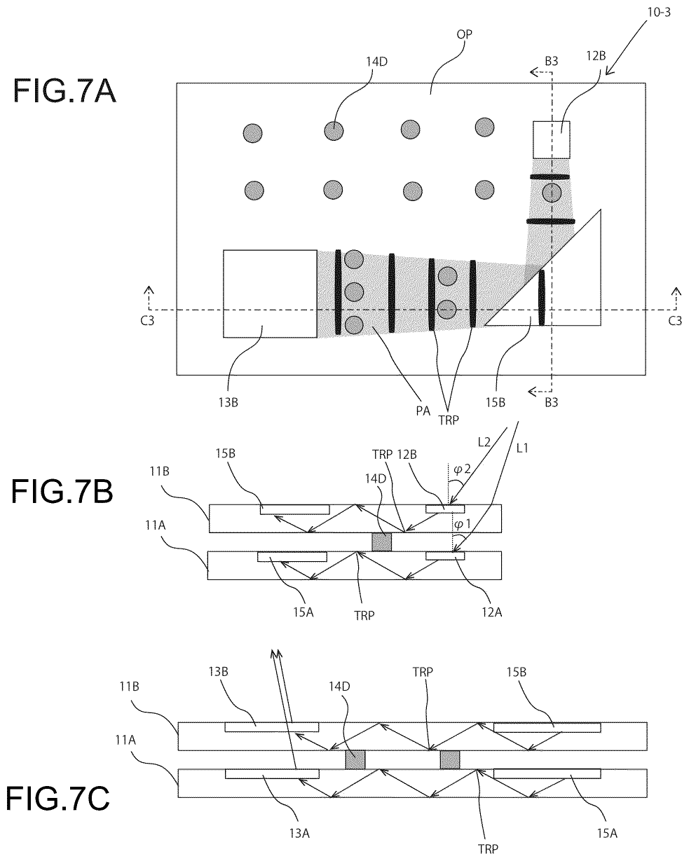

A light guide plate apparatus 10-3 according to Modified Example 3 has, as shown in FIG. 7A and FIG. 7 B (a cross-sectional view taken along the line B3-B3 in FIG. 7A) and FIG. 7 C (a cross-sectional view taken along the line C3-C3 in FIG. 7A), a configuration substantially similar to that of the light guide plate apparatus 10 according to the embodiment except for the fact that third diffraction optical elements (reflective diffraction optical elements) are arranged on the propagation path of the light between the first diffraction optical element and the second diffraction optical element provided in each of the first and second light guide plates 11A and 11B and the fact that a plurality of dot-like spacers 14D is provided inside the outer peripheral portion OP of each light guide plate and outside the propagation region PA of the light between the first and second optical systems OS1 and OS2 in a planar view.

In the light guide plate apparatus 10-3, a third diffraction optical element 15A is arranged on a propagation path of the light between the first diffraction optical element 12A and the second diffraction optical element 13A provided in the first light guide plate 11A. The third diffraction optical element 15A reflects and diffracts the light from the first diffraction optical element 12A and bends the light toward the second diffraction optical element 13A.

In the light guide plate apparatus 10-3, a third diffraction optical element 15B is arranged on a propagation path of the light between the first diffraction optical element 12B and the second diffraction optical element 13B provided in the second light guide plate 11B. The third diffraction optical element 15B reflects and diffracts the light from the first diffraction optical element 12B and bends the light toward the second diffraction optical element 13B.

In the light guide plate apparatus 10-3, at least one (e.g., one) dot-like spacer 14D is provided at a position deviated from the total internal reflection positions TRP between the first and third diffraction optical elements in a planar view. The spacers 14D is located between the two adjacent total internal reflection positions TRP in a planar view.

In the light guide plate apparatus 10-3, a plurality of (e.g., five) dot-like spacers 14D is provided at positions deviated from the total internal reflection positions TRP between the second and third diffraction optical elements in a planar view. Each of the spacers 14D is arranged between the two adjacent total internal reflection positions TRP in a planar view.

In the light guide plate apparatus 10-3, a plurality of (e.g., eight) spacers is arranged, for example, in a matrix form inside the outer peripheral portion OP of each light guide plate and outside the propagation region PA of the light between the first and second optical systems OS1 and OS2 in a planar view.

The light guide plate apparatus 10-3 can also be manufactured by a manufacturing method according to the manufacturing method for the light guide plate apparatus 10 according to the embodiment.

In accordance with the light guide plate apparatus 10-3, incident light can be accurately guided also in a case where the optical system (e.g., at least three diffraction optical elements) is two-dimensionally laid out on the light guide plate.

### Modified Example 4

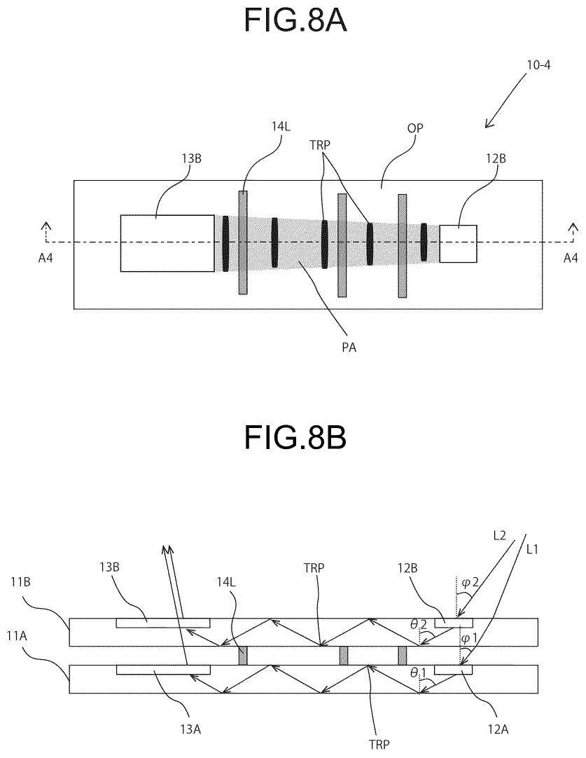

A light guide plate apparatus 10-4 according to Modified Example 4 has, as shown in FIG. 8A and FIG. 8 B (a cross-sectional view taken along the line A4-A4 in FIG. 8A), a configuration similar to the configuration of the light guide plate apparatus 10 according to the embodiment except for the fact that a plurality of (e.g., three) linear spacers 14L is provided.

Each spacer 14L crosses the propagation region PA of the light between the first and second optical systems OP1 and OP2 in a planar view.

The light guide plate apparatus 10-4 can be manufactured by a manufacturing method according to the manufacturing method for the light guide plate apparatus 10 according to the embodiment.

In accordance with the light guide plate apparatus 10-4, effects similar to those of the light guide plate apparatus 10 according to the embodiment can be provided and each spacer 14L includes a portion inside the propagation region PA in a planar view and a portion outside the propagation region PA in a planar view. Therefore, gap variations in the propagation region PA between the respective light guide plates can be more reliably reduced.

It should be noted that at least one of the plurality of linear spacers 14L may be replaced by a curved spacer.

### Modified Example 5

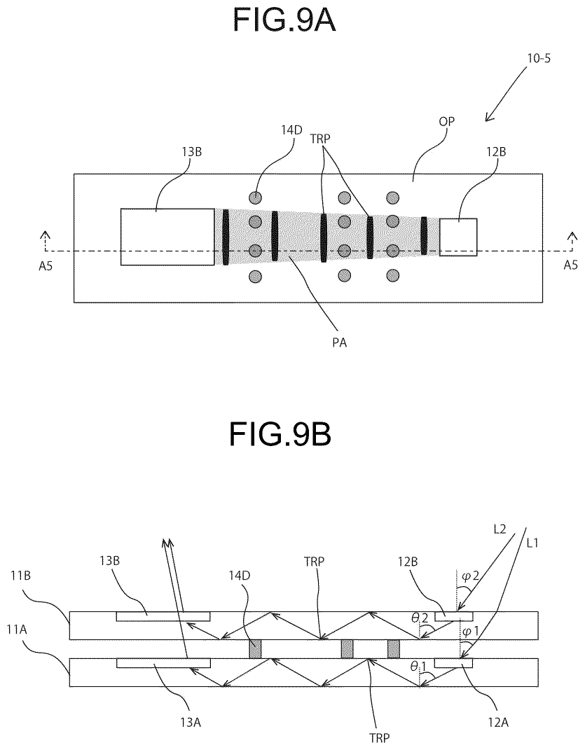

A light guide plate apparatus 10-5 according to Modified Example 5 has, as shown in FIG. 9A and FIG. 9 B (a cross-sectional view taken along the line A5-A5 in FIG. 9A), a configuration similar to the configuration of the light guide plate apparatus 10 according to the embodiment except for the fact that a plurality of (e.g., four) dot-like spacers 14D is arranged side by side, crossing the propagation region PA of the light between the first and second optical systems OP1 and OP2 in a planar view.

The light guide plate apparatus 10-5 can be manufactured by a manufacturing method according to the manufacturing method for the light guide plate apparatus 10 according to the embodiment.

In accordance with the light guide plate apparatus 10-5, effects similar to those of the light guide plate apparatus 10 according to the embodiment can be provided and it includes a spacer positioned inside the propagation region PA and a spacer positioned outside the propagation region PA in a planar view. Therefore, gap variations in the propagation region PA between the respective light guide plates can be more reliably reduced.

### Modified Example 6

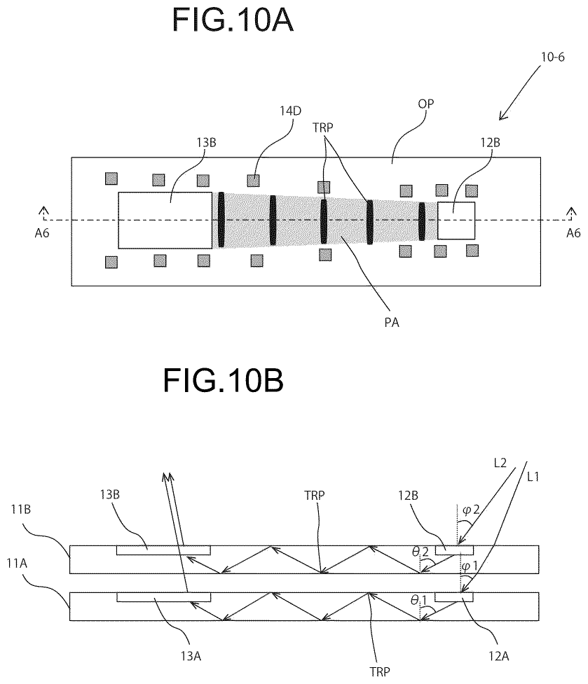

A light guide plate apparatus 10-6 according to Modified Example 6 has, as shown in FIG. 10A and FIG. 10 B (a cross-sectional view taken along the line A6-A6 in FIG. 10A), a configuration similar to the configuration of the light guide plate apparatus 10 according to the embodiment except for the fact that a plurality of (e.g., sixteen) dot-like spacers 14D is positioned inside each of the outer peripheral portions OP of the first and second light guide plates 11A and 11B and outside the propagation region PA in a planar view.

To be more specific, in the light guide plate apparatus 10-6, the plurality of (e.g., sixteen) spacers 14D is arranged side by side along a region including the first diffraction optical elements and the second diffraction optical elements and the propagation region PA in a planar view.

The light guide plate apparatus 10-6 can be manufactured by a manufacturing method according to the manufacturing method for the light guide plate apparatus 10 according to the embodiment.

In accordance with the light guide plate apparatus 10-6, gap variations in the region including the respective diffraction optical elements and the propagation region PA between the respective light guide plates can be sufficiently reduced.

### Modified Example 7

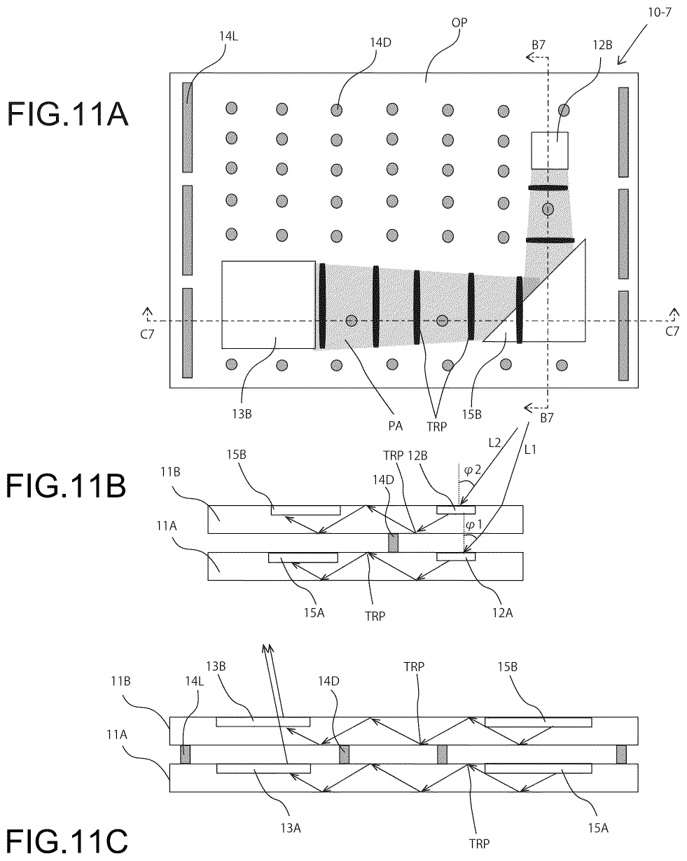

A light guide plate apparatus 10-7 according to Modified Example 7 has, as shown in FIG. 11A and FIG. 11 B (a cross-sectional view taken along the line B7-B7 in FIG. 11A) and FIG. 11 C (a cross-sectional view taken along the line C7-C7 in FIG. 11A), a configuration substantially similar to the configuration of the light guide plate apparatus 10-3 according to Modified Example 3 except for the fact that a plurality of (e.g., six) linear spacers 14L is provided in the outer peripheral portion OP of each light guide plate in a planar view and the arrangement density of a plurality of dot-like spacers 14D provided inside the propagation region PA is greatly different from the arrangement density of a plurality of dot-like spacers 14D provided outside the propagation region PA.

To be more specific, the arrangement density of the plurality of spacers 14D provided outside the propagation region PA is higher than the arrangement density of the plurality of spacers 14D provided inside the propagation region PA.

The light guide plate apparatus 10-7 can be manufactured by a manufacturing method according to the manufacturing method for the light guide plate apparatus 10 according to the embodiment.

In accordance with the light guide plate apparatus 10-7, setting the arrangement density of the spacers 14D inside the propagation region to be lower and the arrangement density of the spacers 14D outside the propagation region to be higher can prevent the plurality of spacers from directly affecting propagation of the light as much as possible and can prevent the plurality of spacers from indirectly affecting propagation of the light as much as possible because gap variations between the light guide plates can be sufficiently reduced. Moreover, in accordance with the light guide plate apparatus 10-7, the plurality of spacers 14L is provided also in the outer peripheral portion OP of each light guide plate in a planar view. Therefore, gap variations between the respective light guide plates can be reduced more stably and reliably.

It should be noted that in contract to the light guide plate apparatus 10-7 according to Modified Example 7, the arrangement density of the spacers 14D inside the propagation region may be set to be higher and the arrangement density of the spacers 14D outside the propagation region may be set to be lower. Alternatively, the arrangement density of the spacers 14D inside the propagation region may be set to be the same as the arrangement density of the spacers 14D outside the propagation region.

Alternatively, the light guide plate apparatus 10-7 may include a single spacer. In this case, the single spacer may include a first portion positioned inside the propagation region PA of the light between the first and second optical systems OS1 and OS2 and a second portion positioned outside the propagation region PA in a planar view and the area density of the second portion may be higher or lower than the area density of the first portion or may be the same as the area density of the first portion.

### Modified Example 8

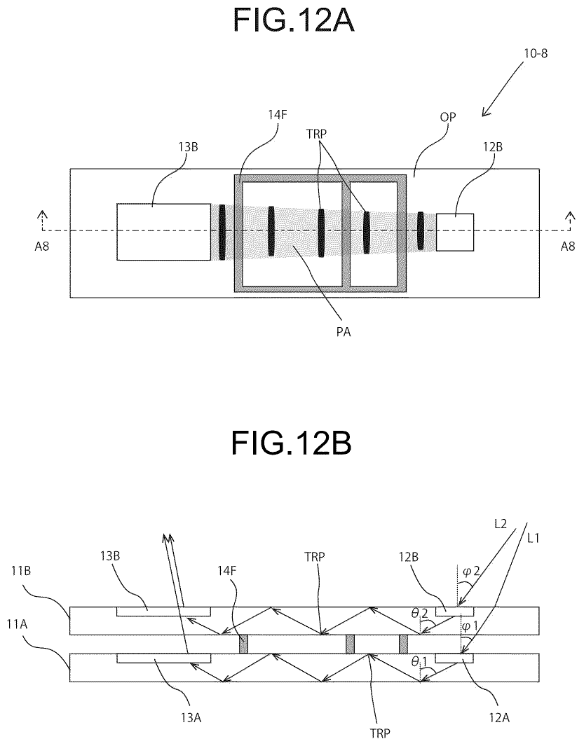

A light guide plate apparatus 10-8 according to Modified Example 8 has, as shown in FIG. 12A and FIG. 12 B (a cross-sectional view taken along the line A8-A8 in FIG. 12A), a configuration similar to the configuration of the light guide plate apparatus 10 according to the embodiment except for the fact that it has a frame-like spacer 14F provided in the outer peripheral portion OP and the propagation region PA of each light guide plate in a planar view.

The light guide plate apparatus 10-8 can be manufactured by a manufacturing method according to the manufacturing method for the light guide plate apparatus 10 according to the embodiment.

In accordance with the light guide plate apparatus 10-8, effects similar to those of the light guide plate apparatus 10 can be provided and gap variations of the respective light guide plates can be reduced more stably.

### Modified Example 9

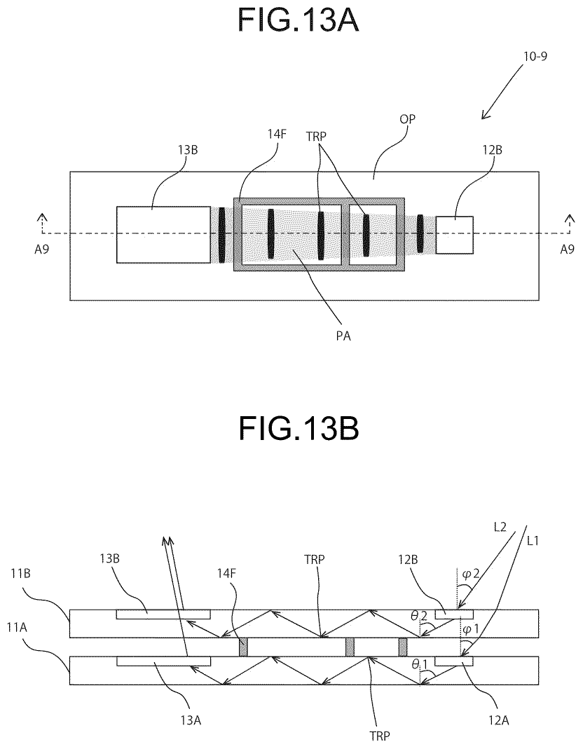

A light guide plate apparatus 10-9 according to Modified Example 9 has, as shown in FIG. 13A and FIG. 13 B (a cross-sectional view taken along the line A9-A9 in FIG. 13A), a configuration similar to the configuration of the light guide plate apparatus 10 according to the embodiment except for the fact that it has a frame-like spacer 14F provided inside and outside the propagation region in a planar view.

The light guide plate apparatus 10-9 can be manufactured by a manufacturing method according to the manufacturing method for the light guide plate apparatus 10 according to the embodiment.

In accordance with the light guide plate apparatus 10-9, effects similar to those of the light guide plate apparatus 10 can be provided and gap variations between the light guide plates in vicinity of the propagation region PA can be more reliably reduced.

### Modified Example 10

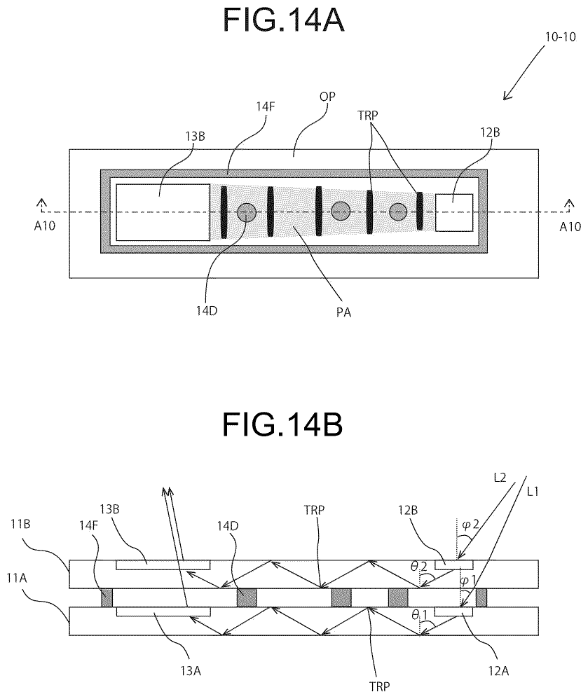

A light guide plate apparatus 10-10 according to Modified Example 10 has, as shown in FIG. 14A and FIG. 14 B (a cross-sectional view taken along the line A10-A10 in FIG. 14A), a configuration substantially similar to that of the light guide plate apparatus 10 according to the embodiment except for the fact that it has a frame-like spacer 14F surrounding a region including the first diffraction optical elements and the second diffraction optical elements and the propagation region in a planar view.

The light guide plate apparatus 10-10 can be manufactured by a manufacturing method according to the manufacturing method for the light guide plate apparatus 10 according to the embodiment.

In accordance with the light guide plate apparatus 10-10, effects similar to those of the light guide plate apparatus 10 can be provided and gap variations between the light guide plates in vicinity of the respective diffraction optical elements and the propagation region can be more reliably reduced.

### Modified Example 11

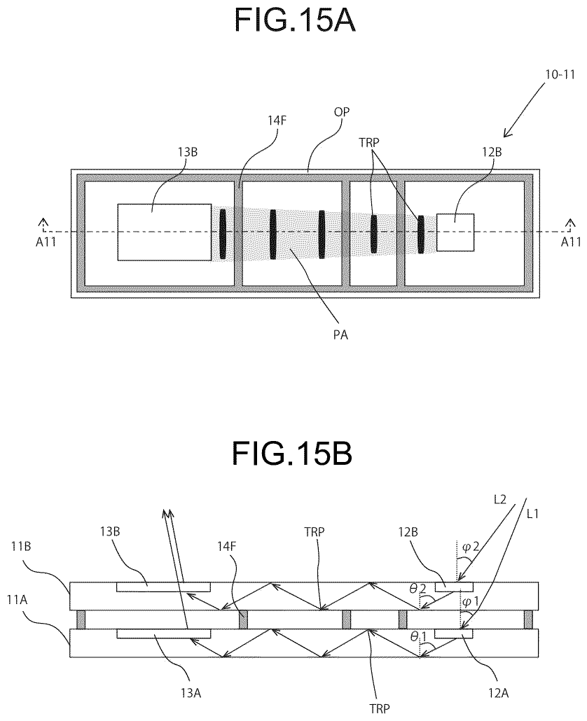

A light guide plate apparatus 10-11 according to Modified Example 11 has, as shown in FIG. 15A and FIG. 15 B (a cross-sectional view taken along the line A11-A11 in FIG. 15A), a configuration substantially similar to that of the light guide plate apparatus 10 according to the embodiment except for the fact that it has a frame-like spacer 14F surrounding a region including the first diffraction optical elements and the second diffraction optical elements and the propagation region PA and including a portion positioned in the outer peripheral portion OP of each light guide plate and a portion crossing the propagation region PA in a planar view.

The light guide plate apparatus 10-11 can be manufactured by a manufacturing method according to the manufacturing method for the light guide plate apparatus 10 according to the embodiment.

In accordance with the light guide plate apparatus 10-11, effects similar to those of the light guide plate apparatus 10 can be provided and gap variations between the light guide plates can be reduced more stably and reliably.

### Modified Example 12

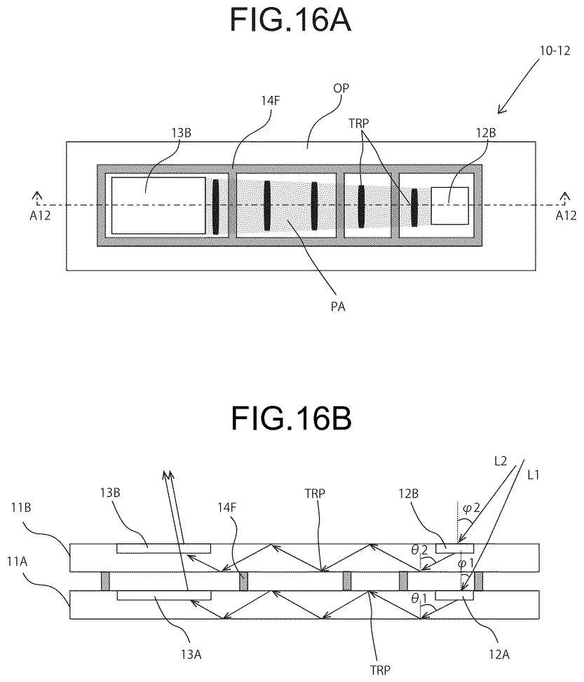

A light guide plate apparatus 10-12 according to Modified Example 12 has, as shown in FIG. 16A and FIG. 16 B (a cross-sectional view taken along the line A12-A12 in FIG. 16A), a configuration substantially similar to that of the light guide plate apparatus 10 according to the embodiment except for the fact that it has a frame-like spacer 14F surrounding a region including the first diffraction optical elements and the second diffraction optical elements and the propagation region PA and including a portion positioned inside the outer peripheral portion OP of each light guide plate and a portion crossing the propagation region PA in a planar view.

The light guide plate apparatus 10-12 can be manufactured by a manufacturing method according to the manufacturing method for the light guide plate apparatus 10 according to the embodiment.

In accordance with the light guide plate apparatus 10-12, effects similar to those of the light guide plate apparatus 10 can be provided and gap variations between the light guide plates in vicinity of the respective diffraction optical elements and the propagation region can be more reliably reduced.

### Modified Example 13

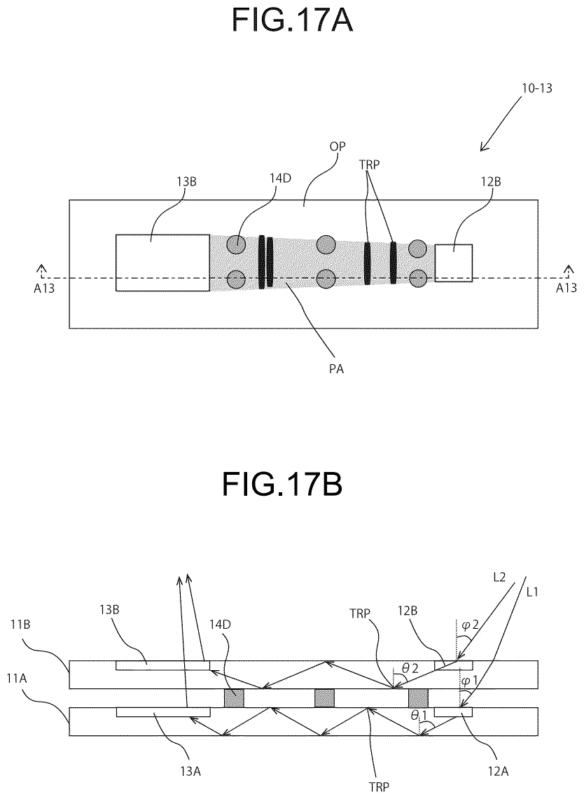

A light guide plate apparatus 10-13 according to Modified Example 13 has, as shown in FIG. 17A and FIG. 17 B (a cross-sectional view taken along the line A13-A13 in FIG. 17A), a configuration similar to the configuration of the light guide plate apparatus 10 according to the embodiment except for the fact that the total internal reflection positions TRP in the corresponding light guide plates of the light rays L1 and L2 obtained by splitting the light per pixel of the image light IL do not overlap each other in a planar view.

The light guide plate apparatus 10-13 can be manufactured by a manufacturing method according to the manufacturing method for the light guide plate apparatus 10 according to the embodiment.

In accordance with the light guide plate apparatus 10-13, the light rays L1 and L2 can be accurately guided also in a case where the total internal reflection positions in the corresponding light guide plates of the light rays L1 and L2 obtained by splitting the light per pixel of the image light IL are deviated from each other in a planar view.

### 4. Modified Examples of Present Technology

The configurations of the image display apparatus including the light guide plate apparatus and the light guide plate apparatus according to each of the embodiment of the present technology and the modified examples described above can be modified as appropriate.

In each of the embodiment and the modified examples described above, the spacers are formed (patterned) by the photolithography, though not limited thereto. The spacers may be formed by, for example, printing such as nanoimprinting and inkjet printing. In a case of forming the spacers by such a printing method, liquid chemicals do not stick the light guide plates and the diffraction optical elements. Therefore, it is advantageous in that it can prevent damage of the light guide plates and the diffraction optical elements.

In each of the embodiment and the modified examples described above, the prism 18 is used as a splitting optical element that splits the image light into the plurality of light rays having different wavelengths. Alternatively, at least one dichroic mirror may be used.

In each of the embodiment and the modified examples described above, the first optical system includes the prism 18 and the first diffraction optical elements respectively provided in the light guide plates, though not limited thereto. For example, the first optical system may include only prisms respectively provided in the light guide plates. In this case, such a prism has both functions as the prism 18 serving as the splitting optical element and the first diffraction optical element.

In each of the embodiment and the modified examples described above, the image light is split into the plurality of light rays having different wavelengths and the plurality of light rays is guided by the different light guide plates. Alternatively, for example, the image light may be split into the plurality of light rays by means of a beam splitter such as a half mirror and the plurality of light rays may be guided by the different light guide plates.

In each of the embodiment and the modified examples described above, transmissive diffraction optical elements are used as the first diffraction optical elements and the second diffraction optical elements. However, a reflective diffraction optical element may be used as at least one of the first diffraction optical elements and the second diffraction optical elements. In this case, the lay-out of the image light generation apparatus 20 and the first and second optical systems OS1 and OS2 may be modified as appropriate.

At least some of the configurations of the embodiment and the respective modified examples described above may be combined in a reasonable range.

Moreover, the present technology can also take the following configurations.

(1) A light guide plate apparatus, including:
a plurality of stacked light guide plates;
a first optical system that causes incident light to enter each of the plurality of light guide plates so as to satisfy a total internal reflection condition inside the light guide plate;
a second optical system that causes the light propagating inside each of the plurality of light guide plates while being totally internally reflected to be emitted outward from the light guide plate; and
at least one spacer provided between two adjacent light guide plates of the plurality of light guide plates, in which
the spacer is arranged at a position deviated from a total internal reflection position of the light in opposite surfaces of each of the two adjacent light guide plates.
   (2) The light guide plate apparatus according to (1), in which
the at least one spacer includes a spacer or portion positioned inside an outer peripheral portion of each of the two adjacent light guide plates in a planar view.
   (3) The light guide plate apparatus according to (2), in which
the at least one spacer includes a spacer or portion positioned at the outer peripheral portion in a planar view.
   (4) The light guide plate apparatus according to any one of (1) to (3), in which
the at least one spacer includes a spacer or portion positioned in a propagation region of the light between the first optical system and the second optical system in a planar view.
   (5) The light guide plate apparatus according to any one of (1) to (4), in which
each of the plurality of light guide plates has a plurality of total internal reflection positions, and
the at least one spacer includes a spacer or portion positioned between two adjacent total internal reflection positions of the plurality of total internal reflection positions in a planar view, the two adjacent total internal reflection positions being adjacent to each other in a propagation direction of the light.
   (6) The light guide plate apparatus according to any one of (1) to (5), in which
the at least one spacer includes a spacer crossing a propagation region of the light between the first optical system and the second optical system in a planar view.
   (7) The light guide plate apparatus according to any one of (1) to (6), in which
the at least one spacer includes at least two spacers arranged side by side so that the at least two spacers cross a propagation region of the light between the first optical system and the second optical system in a planar view.
   (8) The light guide plate apparatus according to any one of (1) to (7), in which
the at least one spacer includes a spacer or portion positioned outside a propagation region of the light between the first optical system and the second optical system in a planar view.
   (9) The light guide plate apparatus according to any one of (1) to (8), in which
the at least one spacer includes a spacer or portion positioned inside an outer peripheral portion of each of the two adjacent light guide plates and outside a propagation region of the light in a planar view.
   (10) The light guide plate apparatus according to any one of (1) to (9), in which
the at least one spacer includes at least one first spacer arranged inside a propagation region of the light between the first optical system and the second optical system and at least one second spacer arranged outside the propagation region in a planar view, and
the first spacer and the second spacer are different in arrangement density.
   (11) The light guide plate apparatus according to (10), in which
the arrangement density of the second spacer is higher than the arrangement density of the first spacer.
   (12) The light guide plate apparatus according to any one of (1) to (11), in which
the at least one spacer includes a first portion positioned inside a propagation region of the light between the first optical system and the second optical system and a second portion arranged outside the propagation region in a planar view, and the first portion and the second portion are different in area density.
   (13) The light guide plate apparatus according to (12), in which
the area density of the second portion is higher than the area density of the first portion.
   (14) The light guide plate apparatus according to any one of (1) to (13), in which
the at least one spacer includes a linear or curved spacer or portion.
   (15) The light guide plate apparatus according to any one of (1) to (14), in which
the at least one spacer includes a dot-like spacer.
   (16) The light guide plate apparatus according to any one of (1) to (15), in which
the at least one spacer includes a frame-like spacer or portion.
   (17) The light guide plate apparatus according to any one of (1) to (16), in which
the first optical system includes
   a first diffraction optical element provided in each of the plurality of light guide plates, and
   an incident optical system that causes the light to enter the first diffraction optical element, and
the second optical system includes a second diffraction optical element provided in each of the plurality of light guide plates.
   (18) The light guide plate apparatus according to (17), in which
at least one diffraction optical element including a third diffraction optical element is arranged on a propagation path of the light between the first diffraction optical element and the second diffraction optical element provided in each of the plurality of light guide plates.
   (19) The light guide plate apparatus according to (18), in which
the third diffraction optical element bends the light from the first diffraction optical element toward the second diffraction optical element.
   (20) The light guide plate apparatus according to any one of (1) to (19), in which
the at least one spacer is formed by photolithography.
   (21) The light guide plate apparatus according to any one of (1) to (20), in which
the at least one spacer is constituted by a polymerizable resin.
   (22) The light guide plate apparatus according to any one of (1) to (21), in which
the at least one spacer is a photospacer.
   (23) The light guide plate apparatus according to any one of (1) to (22), in which
the at least one spacer is constituted by a permanent resist.
   (24) The light guide plate apparatus according to any one of (1) to (23), in which
the at least one spacer has a dimension of 500 μm or less in a direction along an in-plane direction of each of the two adjacent light guide plates.
   (25) The light guide plate apparatus according to any one of (1) to (24), in which
the at least one spacer has a dimension of 100 μm or less in a direction along an in-plane direction of each of the two adjacent light guide plates.
   (26) An image display apparatus, including:
a light guide plate apparatus according to any one of (1) to (25); and
an image light generation apparatus that generates image light and causes the image light to enter a first optical system of the light guide plate apparatus, in which
the first optical system causes different parts of the incident image light to respectively enter a plurality of light guide plates of the light guide plate apparatus, and
a second optical system of the light guide plate apparatus causes light propagating inside each of the plurality of light guide plates to be emitted toward an eyeball of a user.
   (27) The image display apparatus according to (26), in which
the first optical system splits the image light and causes the plurality of split light rays to enter the different light guide plates.
   (28) The image display apparatus according to (27), in which
the plurality of light rays has different wavelengths.

### REFERENCE SIGNS LIST

1: image display apparatus, 10, 10-1 to 10-13: light guide plate apparatus, 11A, 11B, 11C: light guide plate, 12A, 12B, 12C: first diffraction optical element, 13A, 13B, 13C: second diffraction optical element, 14D, 14L, 14D: spacer, 15A, 15B: third diffraction optical element, 18: prism (incident optical system), 20: image light generation apparatus, OS1: first optical system. OS2: second optical system. EB: eyeball. OP: outer peripheral portion, PA: propagation region. TRP: total internal reflection position. IL: image light. L1. L2: light.

What is claimed is:

1. A light guide plate apparatus, comprising:
a plurality of stacked light guide plates;
a first optical system that causes incident light to enter each of the plurality of light guide plates so as to satisfy a total internal reflection condition inside the light guide plate;
a second optical system that causes the light propagating inside each of the plurality of light guide plates while being totally internally reflected to be emitted outward from the light guide plate; and
at least one spacer provided between two adjacent light guide plates of the plurality of light guide plates, wherein
the spacer is arranged at a position deviated from a total internal reflection position of the light in opposite surfaces of each of the two adjacent light guide plates.

2. The light guide plate apparatus according to claim 1, wherein
the at least one spacer includes a spacer or portion positioned inside an outer peripheral portion of each of the two adjacent light guide plates in a planar view.

3. The light guide plate apparatus according to claim 2, wherein
the at least one spacer includes a spacer or portion positioned at the outer peripheral portion in a planar view.

4. The light guide plate apparatus according to claim 1, wherein
the at least one spacer includes a spacer or portion positioned in a propagation region of the light between the first optical system and the second optical system in a planar view.

5. The light guide plate apparatus according to claim 1, wherein
each of the plurality of light guide plates has a plurality of total internal reflection positions, and
the at least one spacer includes a spacer or portion positioned between two adjacent total internal reflection positions of the plurality of total internal reflection positions in a planar view, the two adjacent total internal reflection positions being adjacent to each other in a propagation direction of the light.

6. The light guide plate apparatus according to claim 1, wherein
the at least one spacer includes a spacer crossing a propagation region of the light between the first optical system and the second optical system in a planar view.

7. The light guide plate apparatus according to claim 1, wherein
the at least one spacer includes at least two spacers arranged side by side so that the at least two spacers cross a propagation region of the light between the first optical system and the second optical system in a planar view.

8. The light guide plate apparatus according to claim 1, wherein
the at least one spacer includes a spacer or portion positioned outside a propagation region of the light between the first optical system and the second optical system in a planar view.

9. The light guide plate apparatus according to claim 1, wherein
the at least one spacer includes a spacer or portion positioned inside an outer peripheral portion of each of the two adjacent light guide plates and outside a propagation region of the light in a planar view.

10. The light guide plate apparatus according to claim 1, wherein
the at least one spacer includes at least one first spacer arranged inside a propagation region of the light between the first optical system and the second optical system and at least one second spacer arranged outside the propagation region in a planar view, and
the first spacer and the second spacer are different in arrangement density.

11. The light guide plate apparatus according to claim 10, wherein
the arrangement density of the second spacer is higher than the arrangement density of the first spacer.

12. The light guide plate apparatus according to claim 1, wherein
the at least one spacer includes a first portion positioned inside a propagation region of the light between the first optical system and the second optical system and a second portion positioned outside the propagation region in a planar view, and
the first portion and the second portion are different from each other in area density.

13. The light guide plate apparatus according to claim 12, wherein
the area density of the second portion is higher than the area density of the first portion.

14. The light guide plate apparatus according to claim 1, wherein
the at least one spacer includes a linear or curved spacer or portion.

15. The light guide plate apparatus according to claim 1, wherein
the at least one spacer includes a dot-like spacer.

16. The light guide plate apparatus according to claim 1, wherein
the at least one spacer includes a frame-like spacer or portion.

17. The light guide plate apparatus according to claim 1, wherein
the first optical system includes
a first diffraction optical element provided in each of the plurality of light guide plates, and
an incident optical system that causes the light to enter the first diffraction optical element, and
the second optical system includes a second diffraction optical element provided in each of the plurality of light guide plates.

18. The light guide plate apparatus according to claim 17, wherein
at least one diffraction optical element including a third diffraction optical element is arranged on a propagation path of the light between the first diffraction optical element and the second diffraction optical element provided in each of the plurality of light guide plates.

19. The light guide plate apparatus according to claim 18, wherein
the third diffraction optical element bends the light from the first diffraction optical element toward the second diffraction optical element.

20. The light guide plate apparatus according to claim 1, wherein
the at least one spacer is formed by photolithography.

21. The light guide plate apparatus according to claim 1, wherein
the at least one spacer is constituted by a polymerizable resin.

22. The light guide plate apparatus according to claim 1, wherein
the at least one spacer is a photospacer.

23. The light guide plate apparatus according to claim 1, wherein
the at least one spacer is a permanent resist.

24. The light guide plate apparatus according to claim 1, wherein
the at least one spacer has a dimension of 500 μm or less in a direction along an in-plane direction of each of the two adjacent light guide plates.

25. The light guide plate apparatus according to claim 1, wherein
the at least one spacer has a dimension of 100 μm or less in a direction along an in-plane direction of each of the two adjacent light guide plates.

26. An image display apparatus, comprising:
a light guide plate apparatus according to claim 1; and
an image light generation apparatus that generates image light and causes the image light to enter a first optical system of the light guide plate apparatus, wherein
the first optical system causes different parts of the incident image light to respectively enter a plurality of light guide plates of the light guide plate apparatus, and
a second optical system of the light guide plate apparatus causes light propagating inside each of the plurality of light guide plates to be emitted toward an eyeball of a user.

27. The image display apparatus according to claim 26, wherein
the first optical system splits the image light and causes the plurality of split light rays to enter the different light guide plates.

28. The image display apparatus according to claim 27, wherein
the plurality of light rays has different wavelengths.
